(19) United States
(12) Patent Application Publication
(10) Pub. No.: US 2003/0057651 A1
(43) Pub. Date: Mar. 27, 2003

(54) Assembly forming a magnetic seal, and rolling bearing incorporating such assembly

(75) Inventors: Rene Nantua, Sillingy (FR); Bernard Liatard, Gruffy (FR); Jean-Pierre Sand, Annecy (FR)

Correspondence Address: MICHAEL BEST & FRIEDRICH LLP, 3773 CORPORATE PARKWAY, SUITE 360, CENTER VALLEY, PA, 18034-8217, US

(73) Assignee: The Torrington Company, Torrington, CT

(21) Appl. No.: 09/963,268

(22) Filed: Sep. 25, 2001

(51) Int. Cl. F16J 15/32; F01D 11/02

(52) U.S. Cl. 277/351

(57) ABSTRACT

An assembly comprises a stationary armature to be secured to a stationary support, a moving armature bearing a magnetic disk to be secured to a rotating support, and a seal. The seal covers at least part of an exterior lateral face of a seal support wall of the stationary armature. The seal has at least one dynamic sealing means for rubbing against the rotating support and a ferromagnetic annulus attracted toward the magnetic disk, due to a magnetic field developed by the magnetic disk, to bias the dynamic sealing means against the rotating support. The stationary support and the rotating support may be stationary and rotating rings, respectively, of a bearing, upon which the assembly is mounted.

### BACKGROUND OF THE INVENTION

This invention relates generally to the sealing of rolling bearings and, more particularly, to the sealing of rolling bearings equipped with rotating means that generates pulses such as built-in magnetic encoders.

Many designs of sealing means for rolling bearings are already known in the prior art, as loss of sealing accounts for most rolling bearing failures, particularly in the automotive sector, and more especially in the case of wheel bearings. Reference may, for example, be made to the following documents:

European Patent Applications: 789 152; 785 368; 046 321; 051 170; 053 334; 082 552; 088 517; 098 628; 129 270; 140 421; 153 768; 167 700; 168 092; 208 881; 235 366; 260 441; 286 151; 337 321; 458 122; 458 123; 464 379; 523 614; 541 036; 577 912; 600 659; 608 672; 644 345; 649 762; 656 267; 661 472; 661 473; 676 554; 708 263; 713 021; 748 968; 754 873; 795 702; 807 775; 301 731; 303 359; 304 160; 508 013; 519 654; 737 821; 833 089;

the European Patent Application made by the Applicant No. 378 939.

Regarding seals for rolling bearings equipped with rotating means that generate pulses such as built-in magnetic encoders, reference may, for example, be made to the following European Patent Applications made by the Applicant:

No. 371 836; 376 771; 378 939; 495 323; 607 719; 652 438; 671 628; 725 281.

The wide variety of designs proposed in the prior art for such sealing devices illustrates the fact that a number of technical problems posed by the long-term maintaining of good sealing have not yet found a single satisfactory solution. The use of elastomer coating a reinforcing armature and interfering with rubbing faces has improved the control over the conditions of contact of the dynamic sealing lips of such seals. In spite of this considerable progress, there remains a need for a sealing device, the dynamic sealing means of which display better conditions of contact with their rubbing surface.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the invention, this is accomplished by providing an assembly forming a seal with a built-in magnetic disk, intended to be mounted between a stationary support and a rotating support forming part of a rolling bearing. The assembly comprises a stationary armature to be secured to the stationary support, a moving armature bearing the magnetic disk to be secured to the rotating support, and a seal. The seal covers at least part of an exterior lateral face of a seal support wall of the stationary armature. The seal has at least one dynamic sealing means for rubbing against the rotating support and a ferromagnetic annulus attracted toward the magnetic disk, due to a magnetic field developed by the magnetic disk, to bias the dynamic sealing means against the rotating support.

In a second aspect, the invention relates to a sealed rolling bearing comprising a stationary ring or support and a rotating ring or support and, mounted on them, an assembly forming a seal as set out hereinabove. The exterior lateral surface of the stationary armature is offset inward with respect to a plane tangential to exterior lateral faces of the bearing rings or supports. In an alternative embodiment, the exterior surface of the stationary armature is practically contained in a plane tangential to exterior lateral faces of the bearing rings or supports.

The foregoing and other aspects will become apparent from the following detailed description of the invention when considered in conjunction with the accompanying drawing figures.

### BRIEF DESCRIPTION OF THE DRAWING FIGURES

FIG. 1 is a view in axial section of a seal with built-in magnetic encoders or disk, for a rolling bearing;

FIG. 2 is a view similar to FIG. 1, according to another embodiment;

FIGS. 3 and 4 are views similar to FIGS. 1 and 2, according to other embodiments;

FIG. 5 is a diagram representing the change in the force of attraction of a magnetic seal as depicted in FIG. 2, as a function of air gap; and

FIG. 6 is a diagram similar to FIG. 5 on a half-logarithmic scale.

### DETAILED DESCRIPTION

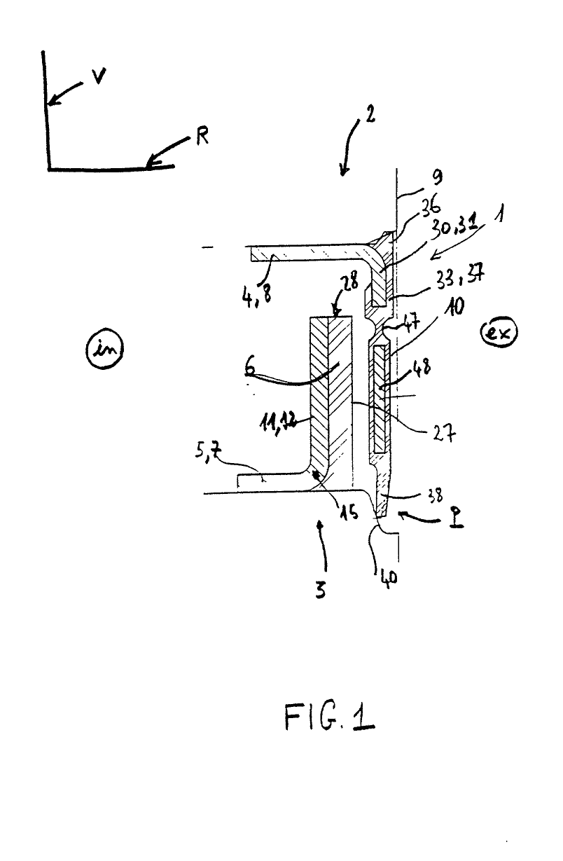

Referring now to the drawings, FIG. 1 is a detail view of a preassembled assembly 1 forming a seal with built-in magnetic disk or magnetic encoder intended to be mounted between a stationary support 2 and a rotating support 3 forming part of a rolling bearing or of a bearing. When the preassembled assembly 1 is mounted in a rolling bearing, the stationary support 2 is the exterior ring of the rolling bearing and the rotating support 3 is the interior ring of the rolling bearing, in the configuration depicted.

A stationary armature 4 is secured to the stationary support 2. Likewise, a moving armature 5 comprising a disk bearing a single-pole magnet or a multi-pole magnetic encoder 6 is secured to the rotating support 3. The person skilled in the art will understand that by switching the stationary 4 and moving 5 armatures, the preassembled assembly 1 can be built into a rolling bearing which has a moving exterior ring and a stationary interior ring.

In the embodiment depicted in FIG. 1, the moving armature 5 is shrunk onto the rotating support 3 via a first cylindrical bearing surface 7, so that the two parts are secured together. Likewise, the stationary armature 4 is shrunk onto the stationary support 2, via a second cylindrical bearing surface 8. In other embodiments, which are not depicted, the stationary armature and/or the moving armature are clipped and/or bonded onto the stationary support and moving support respectively. In other embodiments, which are not depicted, the stationary armature is shrunk onto the exterior of the stationary support.

In the remainder of this description, “internal”, “interior”, “external” and “exterior” will be used with reference to the captions in and ex shown in FIG. 1. Thus, when the preassembled assembly is intended to be built into a rolling bearing, the caption in placed to the left of the moving armature 5 in FIG. 1 corresponds to the interior of the rolling bearing, containing the rolling bodies, and the caption ex placed to the right of the stationary armature 4 in FIG. 1 corresponds to the space beyond the plane P tangential to the exterior lateral face 9 of the stationary support 2.

The direction R is parallel to the axis of rotation of the rotating support 3. In the remainder of the text, for reasons of simplicity, this direction R will be taken to be horizontal and the dimensions measured in this direction R will be said to be “axial”. The direction V perpendicular to the direction R defines, with the direction R, the plane of section of FIG. 1. This direction V is therefore taken as being vertical and the dimensions measured in this direction V will be said to be “radial”.

In the embodiment depicted in FIG. 1, the exterior lateral face 10 of the stationary armature 4 is offset and set back toward the interior with respect to the plane P defined hereinabove. In other embodiments, which have not been depicted, the exterior lateral face of the stationary armature is tangential to said plane P without protruding toward the exterior with respect to this plane. In yet other embodiments, not depicted, the exterior lateral face of the stationary armature projects toward the exterior slightly, beyond said plane P.

The moving armature 5 comprises a base piece 11 comprising, starting from the rotary support 3 and working radially toward the stationary support 2: the first cylindrical bearing surface 7 which is annular and axial; and a radial annular wall 12. A connection fillet 15 connects the first cylindrical bearing surface 7 and the annular wall 12. A multi-pole magnetic encoder 6 or a single-pole magnet disk is overmolded onto the base part 11 of the moving armature 5. This disk or this encoder may, for example, be made of elastomer filled with ferrite such as strontium ferrite or barium ferrite, these examples being nonlimiting.

In the embodiment depicted in FIG. 1, this disk or encoder 6 covers the entire radial span of the wall 12. In other embodiments, not depicted, the disk or encoder 6 covers this wall 12 only in part.

The exterior lateral face 27 of the disk or encoder 6 is approximately vertical and distant from the protective stationary armature 4 by an amount that exceeds the functional clearances, so as to prevent any contact between the disk or encoder 6 and the stationary armature 4. The annular face 28 placed facing the cylindrical bearing surface 8 of the stationary armature is likewise separated from this bearing surface 8 so as to prevent any contact between the disk 6 and this bearing surface 8 as the disk 6 rotates.

The stationary armature 4 comprises an internal piece 30 comprising, starting from the stationary support 2 and working radially toward the rotating support 3: the second cylindrical bearing surface 8; and a deflecting radial annular wall supporting a seal 31. The internal piece 30 and the seal 33 overmolded onto this internal piece 30 are nonmagnetic and do not in any way disturb the field lines emanating from the disk 6. So that when this disk 6 is a multi-pole magnetic encoder, a sensor can read the pulses emitted by the encoder 6, through the stationary armature 4.

The seal 33 comprises, starting from the stationary support 2 and working radially toward the rotating support 3: a static sealing heel 36; an annular band 37 overlapping the wall 31; and a dynamic sealing lip 38. In one alternative form, not depicted, the seal has no sealing heel. This sealing lip 38 is pressed, with interference, against the exterior lateral face 40 of the rotating support 3. The seal has a thinned section 47 and a ferromagnetic circular annulus 48. The ferromagnetic circular annulus may be coated in the material of the seal 33 or comprise at least one part lying flush with said seal 33 on the internal face, The annulus 48 may or may not be continuous.

Under the action of the magnetic field developed by the disk 6, the ferromagnetic annulus 48 is attracted toward the disk 6, the thinned section 47 of the seal forming an articulation. This results in a force pressing the dynamic sealing lip 38 against the wall 410. When the disk 6 is a multi-pole magnetic encoder, the ferromagnetic annulus is of a size and nature, which are such that the field lines are not disturbed.

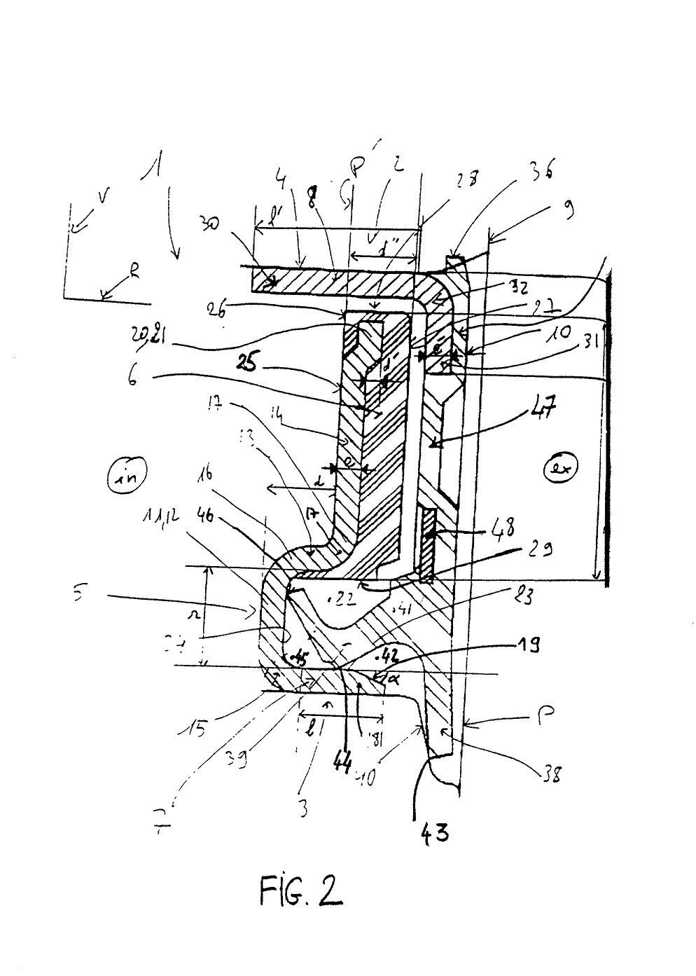

Reference is now made to FIG. 2. The elements, which are common to the various embodiments, are referenced in the same way.

The moving armature 5, at present in the embodiment of FIG. 2, will now be described in fuller detail. The moving armature 5 comprises an annular base piece 11 comprising, starting from the rotating support 3 and working radially toward the stationary support 2, in the embodiment depicted: the first cylindrical bearing surface 7 which is annular and axial; a first annular wall 12 which is radial; a second annular wall 13, which is axial; a third annular wall 14 which is radial and offset by an axial distance d with respect to the first annular wall 12.

The first annular wall 12 and the third annular wall 14 are approximately parallel to each other and parallel to the plane P in the embodiment depicted. The first cylindrical bearing surface 7 and the second annular wall 13 are approximately concentric and their lines in the plane of FIG. 1 are approximately parallel to the direction R. A first connection fillet 15 connects the first cylindrical bearing surface 7 and the first annular wall 12. A second connection fillet 16 connects the first annular wall 12, which is radial, to the second annular wall 13, which is axial. A third connection fillet 17 connects the second annular wall 13, which is axial, to the third annular wall 14, which is radial.

The first end part 18 of the base piece 11 has a chamfer 19 forming a cone frustum, of which the line, in the plane of FIG. 1, is inclined by an angle a of between 5 and 30° approximately with respect to the horizontal. The second end part 20 of the base piece 11 comprises a cutout 21 toward the exterior, forming a fourth annular wall which is radial and offset toward the exterior by an axial distance d′ with respect to the third annular wall 14. In the embodiment depicted, the distance d′ is of the order of half the thickness e defined hereinabove. With the exception of the first end part 18, which is chamfered, the annular base piece 11 of the moving armature 5 has an approximately constant thickness e.

The first cylindrical bearing surface 7, the first annular wall 12 and the second annular wall 13 form, with the connection fillets 15, 16, an annular groove 22, the opening of which faces toward the exterior. In the embodiment depicted in FIG. 2, this annular groove 22 exhibits, in the axial sectioning plane under consideration, a U-shaped profile the maximum axial dimension of which is practically identical to its maximum radial dimension. In other words, in the embodiment depicted, the axial length j of the cylindrical bearing surface 8 is approximately equal to the radial dimension r of the first annular wall 12.

The exterior lateral face of the annular groove 22 comprises an axial annular surface 23 and a radial annular surface 24 which, as will be more fully apparent hereinafter, form bearing surfaces for dynamic sealing means arranged on the stationary armature 4 of the assembly 1. The base piece 11 of the moving armature 5 may be made of a ferromagnetic material such as X4Cr17 stainless steels, for example.

A one-pole magnet or a multi-pole magnetic encoder disk 6 is overmolded onto the base part 11 of the moving armature 5. This single-pole or multi-pole disk may, for example, be made of elastomer filled with ferrite such as strontium ferrite, or barium ferrite, these examples being nonlimiting. Other fillers capable of yielding high magnetic flux densities per unit volume may theoretically be envisaged, for example magnetic neodymium-iron-cobalt or samarium-cobalt alloys, although ferrites are far less expensive and far easier to magnetize and are therefore most often preferred.

The disk 6 covers an entire lateral surface of the second 13, third 14 and fourth lateral walls of the base part 11 and coats the recess 21 formed on the second end part 20 of this base piece 11. The annular internal lateral surface 25 of the third annular wall 14 is approximately placed in the continuity of the annular internal lateral surface 26 of the disk 6 in a transverse plane P′ separated by a distance d″ from the exterior lateral face 27 of the disk 6, so that the disk 6 projects toward the exterior, on the third annular wall 14, by an axial dimension of the order of twice the thickness e of the base part 11.

The exterior lateral face 27 of the disk 6 is approximately vertical and distant from the stationary arm 4 that protects the disk 6 by an amount which is greater than the functional clearances so as to prevent any contact between the disk 6 and the stationary armature 4. The annular face 28 placed facing the cylindrical bearing surface 8 of the stationary armature 4 is likewise separated from this bearing surface 8 so as to prevent any contact between the disk 6 and this bearing surface 8 as the disk 6 rotates.

In the embodiment depicted, the disk 6 is radially bounded by the annular face 28 and an annular face 29 approximately concentric with the face 28 and with the axial annular surface 23 of the first bearing surface 7. The annular face 29 is distant from the axial annular surface 23 by the amount r defined hereinabove. The maximum radial dimension r′ of the disk 6, represented by the radial distance separating the annular faces 28, 29, is of the order of three times the value r defined hereinabove, in the embodiments under consideration.

The stationary armature will now be described in fuller detail. The stationary armature comprises an internal piece 30 comprising, starting from the fixed support 2 and working radially toward the rotating support 3: the second cylindrical bearing surface 8; and a deflecting radial annular wall which supports a seal 31. A connection fillet connects the second cylindrical bearing surface 8, which is axial, and the sealing support wall 31. The internal part 30 of the stationary armature 4 has a thickness e′ which is approximately constant.

The internal piece 30, in the axial sections depicted in FIGS. 1 and 2, has an L-shaped profile, the maximum axial dimension of which exceeds this maximum radial dimension. In other words, in the embodiments depicted in FIGS. 1 and 2, the axial length 1′ of the second cylindrical bearing surface 8 exceeds the radial dimension r″ of the seal support wall. This radial dimension r″ of the wall 31 is shorter than the maximum radial dimension r′ of the disk 6. The internal part 30 of the stationary armature may be solid or otherwise, and is made of a nonmagnetic material such as a polymer or certain stainless steels, for example, so that the seal support wall 31 is perfectly magnetically transparent and does not in any way disturb the field lines emanating from the disk 6, so that when the disk 6 is an encoder, a sensor can read the pulses emitted by the encoder.

The seal support wall 31 is approximately parallel to the exterior lateral face 27 of the disk and approximately parallel to the planes P and P′ defined hereinabove. An overmolded seal 33 covers the exterior lateral face 34 of the wall 31 and coats the end part 35 of this wall. This seal 33 comprises, starting from the stationary support 2 and working radially toward the rotating support 3: a static sealing heel 36; an annular band 37 overlapping the wall 31; and two dynamic sealing lips 38, 39. In other embodiments, which have not been depicted, this seal comprises, starting from the stationary support 2 and working radially toward the rotating support 3, just two dynamic sealing lips.

The sealing lip 38 placed approximately in the continuation of the wall 31 and slightly inclined with respect to the latter, bears against the exterior lateral face 40 of the rotating support 3. The sealing lip 39 articulated about a hinge 41 bears with interference in the groove 22 against the faces 23, 24 of the base piece of the moving armature 5. Thus, the dynamic sealing lip 39 is preloaded in the vertical direction, in one embodiment.

The geometry of the dynamic sealing lip 38, 39 means that the space separating the exterior face 27 of the disk 6 and the stationary armature 4 is separated from the exterior surroundings ex by two compartments: a first compartment 42 bounded by the contact 43 between the lip 38 and the rotating support 3, on the one hand, and the contact 44 between the lip 39 and the surface 23 of the bearing surface 7, on the other hand; and a second compartment 45 bounded by the above defined contact 44, on the one hand, and by the contact 46 between the lip 39 and the surface 24 of the wall 12, on the other hand. These two grease-filled compartments may act as a lock chamber, limiting the ingress of contaminants toward the interior of the rolling bearing.

The seal 33 may be solid or otherwise and is made of an elastomer such as VITON, acrylonitrile or any other equivalent material chosen according to the application. The seal has a thinned section 47 and a ferromagnetic circular annulus 48. The ferromagnetic annulus may be coated with the material of the seal or comprise at least one part lying flash with said seal on the internal face. In the embodiment depicted, in axial section, the ferromagnetic circular annulus is of rectangular section. In other embodiments, which have not been depicted, the section of the circular annulus 48 in the axial plane of FIGS. 1 or 2 is oval, circular, polygonal or some other shape.

The ferromagnetic circular annulus 48 may or may not be continuous. Its axial thickness may be constant, regardless of the plane of section considered or, on the other hand, may vary, this being in order, for example, to account for asymmetric loading of the rolling bearing or bearing in which the seal is fitted. The ferromagnetic circular annulus 48 is completely coated with the seal, in the embodiment depicted. When the disk 6 is an encoder, the ferromagnetic annulus has dimensions such that it does not appreciably disturb the field lines.

Under the action of the magnetic field developed by the disk 6, the ferromagnetic annulus 48 is attracted toward the disk 6, the thinned section 47 of the seal forming an articulation. This attraction of the ferromagnetic annulus 48 by the disk 6 results in a force that compresses the dynamic sealing lips 38, 39 onto the contacts 43 and 46 defined hereinabove.

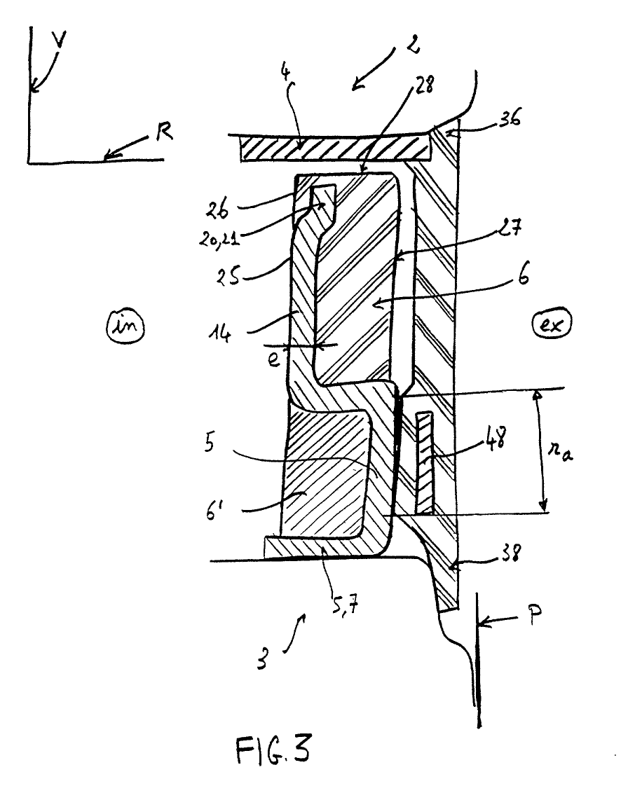

Reference is now made to FIG. 3. The moving armature 5 has an upper radial end part similar to that of the embodiment of FIG. 2, and will therefore not be described again. By contrast, its lower radial end part has the shape of a U, which is open toward the interior, defining an annular groove in which a single-pole or multi-pole magnet 6′ is placed.

The stationary armature 4 comprises a seal with a single dynamic sealing lip 38 pressed with interference against the exterior wall 40 of the moving support 3. The seal bears, on an annular band of radial dimension rₐ, against the moving armature 5. Sealing is achieved through the sliding contact between the exterior surface of the moving armature 5 and the interior surface of the seal. In another embodiment, the piece 48 is flush and there is contact between said piece 48 and the metallic surface of the moving armature 5.

The single-pole or multi-pole magnet 6′ attracts the ferromagnetic piece 48 placed facing it, the piece 48 being embedded in the seal, so that permanent force ensures contact between the exterior surface of the moving armature 5 and the interior face of the seal. Just as in the embodiment of FIGS. 1 and 2, the seal may, outside of the piece 48, be made of a nonmagnetic material. A sensor placed facing the encoder 6 may therefore read the pulses emitted by the encoder 6 through the seal.

The preassembled assembly 1 forming a seal with two built-in magnetic disks, as depicted in FIG. 3, can be mounted between a stationary support 2 and a rotating support 3 forming part of a rolling bearing or of a bearing intended for a driven wheel of a motor vehicle. The ferromagnetic moving support may be made of stainless steel, so as to allow the field to pass through.

The embodiment of FIG. 4 is of the same kind as that of FIG. 3. The moving armature 5 has a first radial end part similar to the upper end part of the moving armatures of the embodiment of FIGS. 2 and 3 and will therefore not be described again. The second radial end part has the shape of the U open toward the interior defining an annular groove in which a single-pole or multi-pole magnet 6′ is placed, just as in the embodiment of FIG. 3. Likewise, the stationary armature 4 comprises a seal with a single dynamic sealing lip 38. This sealing lip 38 is pressed with interference against an exterior lateral face of the moving armature 5.

Just as in the embodiment of FIG. 3, the seal bears on an annular band of radial dimension rₐ, against the moving armature 5. Sealing is achieved through sliding contact between the exterior surface of the moving armature 5 and the interior surface of the seal. The single-pole or multi-pole magnet 6′ attracts the ferromagnetic piece 48 embedded in the seal, this piece 48 lying facing the single-pole or multi-pole magnet 6′. Just as in the previous embodiments, the seal may, except for the piece 48, be made of a nonmagnetic material. A sensor such as a magnetoresistor or Hall-effect probe will therefore be capable of reading the pulses emitted by the encoder to the seal.

The preassembled assembly 1 depicted in FIG. 4, forming a seal with two built-in magnetic disks intended to be mounted between a stationary support 2 and a rotating support 3 is more particularly suited to forming part of a rolling bearing for a non-driven wheel of a motor vehicle.

In the embodiments considered hereinabove and depicted in FIGS. 1 to 4, when the disk 6 is a rotating means generating pulses, the fitting of a sensor of the magnetoresistor or Hall-effect probe type may be performed with a large air gap, even on rolling bearings of small diameter, this sensor being dissociated from the rolling bearing and not altering its geometry, the rolling bearing being equipped with means for protecting the encoder so that the risk of the deposition of ferromagnetic particles such as chips on the encoder protector are low, any deposition there might be not disturbing the signal emanating from the sensors.

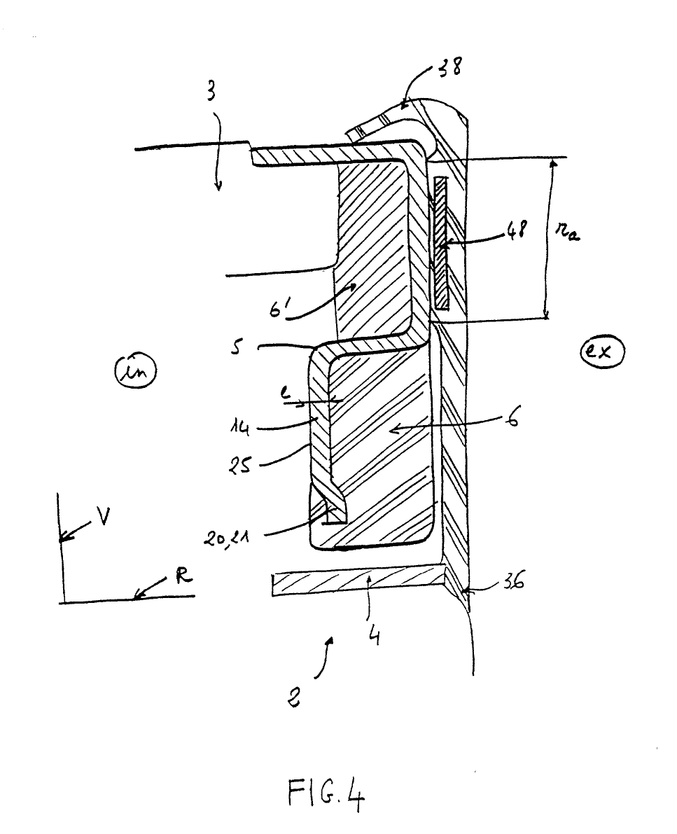

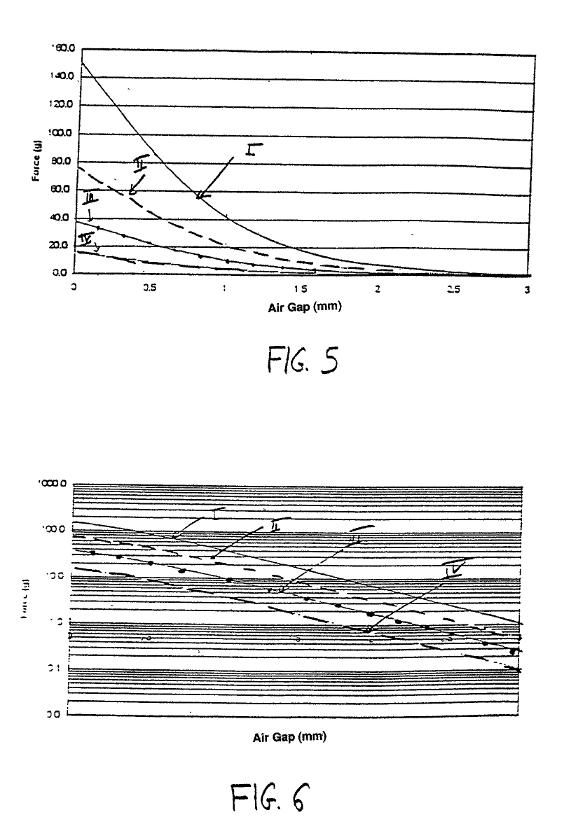

FIGS. 5 and 6 illustrate the variation in the force of adhesion of the lips 38, 39 ;as a function of the air gap, for various values of the ratio between the area of the ferromagnetic annulus and the area of the disk 6, for a geometry as depicted in FIG. 2. Curve I of FIGS. 5 and 6 corresponds to a reference, the total area of the ferromagnetic annulus being equal to the area S₀ of the encoder 6. Curves II, III and IV of FIGS. 5 and 6 correspond respectively to ratios between the area of the ferromagnetic annulus and the area S₀ of the encoder 6 of 1/2, 1/4 and 1/10. FIGS. 5 and 6 show that it is possible to obtain significant attractive force, even for large air gaps.

Having described the invention, what is claimed is:

1. An assembly forming a seal with a built-in magnetic disk, intended to be mounted between a stationary support and a rotating support forming part of a rolling bearing, the assembly comprising:
a stationary armature to be secured to the stationary support;
a moving armature bearing the magnetic disk, to be secured to the rotating support;
a seal covering at least part of an exterior lateral face of a seal support wall of the stationary armature, the seal having at least one dynamic sealing means for rubbing against the rotating support and a ferromagnetic annulus attracted toward the magnetic disk, due to a magnetic field developed by the magnetic disk, to bias the dynamic sealing means against the rotating support.

2. An assembly according to claim 1, wherein the seal further comprises at least one static sealing heel for contact with an upper lateral wall of the stationary support.

3. An assembly according to claim 1, wherein the moving armature comprises a first wall and a third wall that is offset axially outward with respect to the first wall, the first wall being connected by a connection fillet to a first cylindrical surface for bearing against the moving support, the third wall bearing the magnetic disk.

4. An assembly according to claim 3, wherein the first annular wall and a second annular wall of the moving armature form an annular groove.

5. An assembly according to claim 4, wherein, in axial section, the annular groove has a profile including one of the following shapes: a U-shape, a pseudo-U-shape, a V-shape and a pseudo-V-shape.

6. An assembly according to claim 5, wherein an exterior lateral face of the groove comprises a bearing surface for at least one dynamic sealing lip.

7. An assembly according to claim 1, wherein the magnetic disk is made of a material chosen from the group comprising elastomers filled with strontium ferrite or barium ferrite and their equivalents.

8. An assembly according to claim 5, wherein a dynamic sealing lip is configured to bear against an exterior lateral face of the rotating support.

9. An assembly according to claim 6, wherein the dynamic sealing means includes a dynamic sealing lip articulated about a hinge such that the dynamic sealing lip bears against the bearing surface of the annular groove.

10. An assembly according to claim 1, wherein the magnetic disk is a single-pole magnetic disk.

11. An assembly according to claim 1, wherein the magnetic disk is a multi-pole magnetic encoder.

12. An assembly according to claim 11, further comprising a single-pole or multi-pole magnet in addition to the multi-pole encoder.

13. An assembly according to claim 12, wherein the single-pole or multi-pole magnet is located in a groove of the moving armature and attracts the ferromagnetic annulus.

14. An assembly according to claim 1, wherein the seal bears, on an annular band of radial dimension rₐ, against the moving armature, sealing being achieved by sliding contact between an exterior surface of the moving armature and an interior surface of the seal.

15. An assembly according to claim 14, wherein the moving armature has an end part defining an annular groove in which a magnet is placed.

16. An assembly according to claim 14, wherein the stationary armature comprises a seal with a single dynamic sealing lip.

17. An assembly according to claim 16, wherein the dynamic sealing lip forms an interference fit with an exterior wall of the moving support.

18. An assembly according to claim 17, wherein the dynamic sealing lip forms an interference fit with an exterior annular lateral face of the moving armature.

19. A sealed rolling bearing comprising:
a stationary ring;
a rotating ring;
a stationary armature mounted on the stationary ring;
a moving armature bearing a magnetic disk, mounted on the rotating ring; and
a seal covering at least part of an exterior lateral face of a seal support wall of the stationary armature, the seal having at least one dynamic scaling means in contact with the rotating ring and a ferromagnetic annulus attracted toward the magnetic disk, due to a magnetic field developed by the magnetic disk, to bias the dynamic sealing means against the rotating ring.

20. A sealed rolling bearing according to claim 19, wherein an exterior lateral surface of the stationary armature is offset inward with respect to a plane tangential to exterior lateral faces of the stationary and rotating rings.

21. A sealed rolling bearing according to claim 20, wherein the exterior lateral face of the stationary armature is practically contained in the plane tangential to the exterior lateral faces of the bearing rings or supports.
